(19) United States
(12) Patent Application Publication
(10) Pub. No.: US 2006/0212583 A1
(43) Pub. Date: Sep. 21, 2006

(54) Distributing messaging session logs to users entering an already ongoing messaging session

(76) Inventors: Bruce A. Beadle, Round Rock, TX (US); Michael A. Paolini, Austin, TX (US); Colin James Parris, Austin, TX (US)

Correspondence Address: IBM CORP (AP);C/O AMY PATTILLO, P. O. BOX 161327, AUSTIN, TX, 78716, US

(21) Appl. No.: 11/083,212

(22) Filed: Mar. 17, 2005

(51) Int. Cl. G06F 15/16

(52) U.S. Cl. 709/227; 709/206

(57) ABSTRACT

A method, system, and program for distributing messaging session logs to users entering an already ongoing messaging session are provided. When, first and second user are participating in an ongoing instant messaging session and an additional user enters the instant messaging session, the additional user can only see those entries in the instant messaging session that occur after the additional user enters the messaging session. A logging controller, however, automatically records a log of all the entries in the messaging session when the logging controller detects the entrance of an additional user to an ongoing messaging session. Then, the logging controller provides a selectable option for the first or second user, the selection of which triggers the logging controller to pass the log of previous entries to the additional user. The first or second user may also select to view the log and select or edit those entries within the log of previous entries that the logging controller may pass to the additional user. Further, the first or second user may select to view the log and select those entries within the log of previous entries to add to the current messaging session that includes the first user, second user, and additional user.

### BACKGROUND OF THE INVENTION

1. Technical Field

The present invention relates in general to improved messaging systems and in particular to improving distribution of logs of entries in instant messaging sessions. Still more particularly, the present invention relates to facilitating distribution of instant messaging session logs to users entering an already ongoing instant messaging session.

2. Description of the Related Art

The use of electronic messaging and communications, such as electronic mail (e-mail), instant messaging, and text messaging has expanded rapidly over the last few years. Typically, an e-mail application, such as Lotus Notes (Lotus Notes is a registered trademark of International Business Machines Corporation), provides a user interface between the user and an e-mail server that sends and receives e-mail via a network, such as the Internet. In addition, typically, instant messaging applications and chat applications, such as AOL Instant Messenger (AIM) (AOL and AIM are registered trademarks of AOL, Inc.), provide a user interface between the user and an instant messaging server that opens a communication channel between at least two users and facilitates distribution of messages through that communication channel.

Since instant messaging is essentially “real-time” communication, this type of electronic communication is often used when users need to communicate immediately about a particular topic. As it evolves, instant messaging is commonly used as a substitute for telephone calls because the conversation can happen in “real-time” but all parties to the messaging session can remain at their computer system or portable electronic device and respond when needed.

However, since instant messaging sessions provide “real-time” communication, when additional users joins an instant messaging session already ongoing between two or more original participants, the additional users only sees those messages entered by the additional users and the original participants after the additional users joins the ongoing messaging session. In many cases, however, it is limiting for additional users not to know the contents of the previous conversation within that particular instant messaging session.

Therefore, in view of the foregoing, it would be advantageous to provide a method, system, and program for recording a log of those entries made in a messaging session at the point an additional user joins the messaging session while it is ongoing and distributing the log to the additional user. Further, it would be advantageous to enable the original users of the ongoing messaging session to edit previous messaging entries or selection only particular message entries to distribute to the additional user in the log. Moreover, where instant messaging is used in a business context or other context where a third party is represented, it would be advantageous to apply third party rules to how instant messaging logs can be distributed.

### SUMMARY OF THE INVENTION

Therefore, the present invention provides an improved messaging systems and in particular provides an improved method, system, and program for improving distribution of logs of entries in instant messaging sessions. Still more particularly, the present invention provides a method, system, and program for facilitating distribution of instant messaging session logs to users entering an already ongoing instant messaging session.

The present invention provides for improved control over the recording, sharing, editing, and storing of messaging session logs. In particular, a logging controller may control the recording, sharing and editing of messaging session logs according to logging rules. A user, group of users, or third party may specify the logging rules applied by the logging controller.

As for sharing and editing messaging session logs, in one example, when a first and second user are participating in an ongoing instant messaging session and an additional user enters the instant messaging session, initially the additional user can only see those entries in the instant messaging session that occur after the additional user enters the messaging session. In many cases, the additional user needs to view the entries in the messaging session prior to the point of entry. Therefore, according to one advantage, a logging controller automatically records a log of all the entries in the messaging session when the logging controller detects the entrance of an additional user to an ongoing messaging session. Then, in one example, the logging controller provides a selectable option for the first or second user, the selection of which triggers the logging controller to pass the log of previous entries to the additional user. According to another example, the first or second user may select to view the log and select or edit those entries within the log of previous entries that the logging controller may pass to the additional user. According to yet another example, either the first or second user may select to view the log and select those entries within the log of previous entries to add to the current messaging session that includes the first user, second user, and additional user.

According to another advantage, a logging controller enables the merging of multiple independent messaging sessions into a single messaging session. When a user or a controller selects to merge a first messaging session into a second messaging session to form a group messaging session, the users in the first messaging session do not see the previous entries in the second messaging session and the users in the second messaging session do not see the previous entries in the first messaging session, but all the users will see all entries entered after the merging point. According to an advantage, logging controller may automatically transfer the log of the first messaging session to the users from the second messaging session and the log of the second messaging session to the users from the first messaging session. In another example, one of the users of the first messaging session may select for the logging controller to pass the log of the first messaging session to users from the second messaging session. Further, as previously described, the logging controller enables users to edit a log before the log is sent to another user and to select portions of the log to add to a current messaging session log.

The interfaces through which an additional user, who upon entering an ongoing messaging session receives a log of previous entries, may vary. In one example, the additional user may view the log in a window independent from the window displaying the current messaging session entered by the additional user. In another example, the additional user may view the log a window split between the log and the current messaging session entered by the additional user.

When the participants in a messaging session end the messaging session, the logging controller stores a log of the messaging session with data tagging the entry and exit point of participants, the portions of the message log shared with additional users, and the editing performed by users. In one example where the logging controller merges multiple messaging sessions, the logging controller may store a copy of the log of the merged messaging session in the group project folders of each of the merged messaging session groups.

Further, when the participants in a merged messaging session end the messaging session, the logging controller enables users to select to reconvene the merged messaging session with a single input selection. In the request to reconvene users may select that all previous attendees are prompted to join and the log of the previous merged messaging session replayed. In addition, if the merged messaging session is reconvened, the logging controller may monitor when any previous participants become available and prompt the newly available previous participants to join the reconvened messaging session.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer in which the present method, system, and program may be implemented;

FIG. 2 is a block diagram illustrating a distributed network system for facilitating distribution of electronic messages between a requester and a recipient for facilitating one embodiment of the present invention;

FIG. 3 is a block diagram depicting a network system with a logging controller for facilitating the distribution of messaging session logs according to logging rules;

FIG. 4 is a block diagram illustrating components of a logging controller;

FIG. 5 is a block diagram depicting examples of global log rules;

FIG. 6 is a block diagram illustrating the logging options provided to users participating in a messaging session when an additional user joins the ongoing messaging session;

FIG. 7 is a block diagram depicting examples of logging options provided to users merging messaging sessions;

FIG. 8 is a block diagram illustrating an example of a group messaging interface;

FIG. 9 is an illustrative example of an interface for prompting users to approve a distribution of a log to an additional user;

FIG. 10 is a high level logic flowchart illustrating a process and program for controlling distribution of an instant messaging session log to a user joining an ongoing instant messaging session; and

FIG. 11 is a high level logic flowchart depicting a process and program for controlling distribution of an instant messaging log of a first instant messaging session when a user participating in the first ongoing messaging session joins a second instant messaging session.

### DETAILED DESCRIPTION OF THE PREFERRED EMBODIMENT

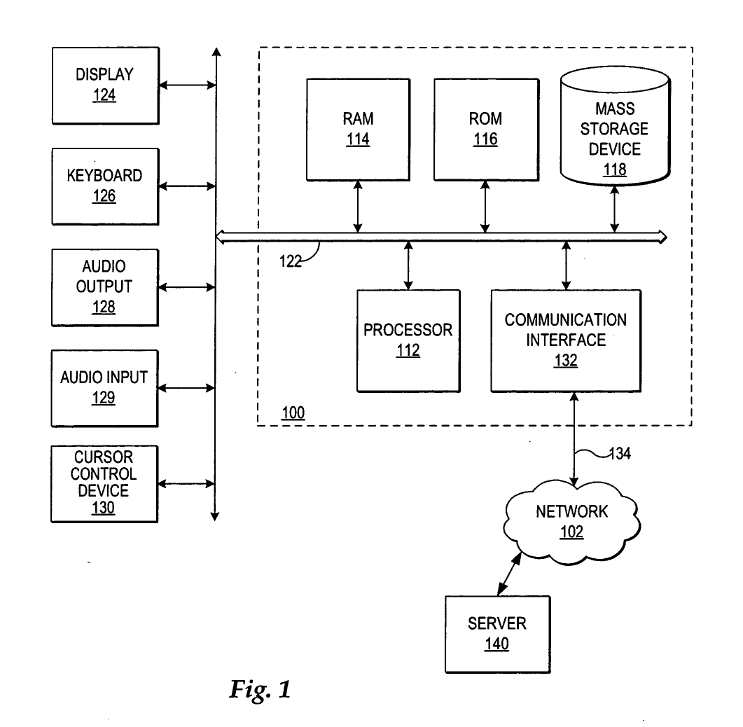

Referring now to the drawings and in particular to FIG. 1, a block diagram depicts one embodiment of a computer which may implement the present invention. In particular, a computer may include multiple types of systems, including, but not limited to, a computer system 100 and including multiple combinations of computer systems and electronic devices.

Computer system 100 includes a bus 122 or other communication device for communicating information within computer system 100, and at least one processing device such as processor 112, coupled to bus 122 for processing information. Bus 122 includes low-latency and higher latency paths connected by bridges and adapters and controlled within computer system 100 by multiple bus controllers. When implemented as a server system, computer system 100 typically includes multiple processors designed to improve network servicing power.

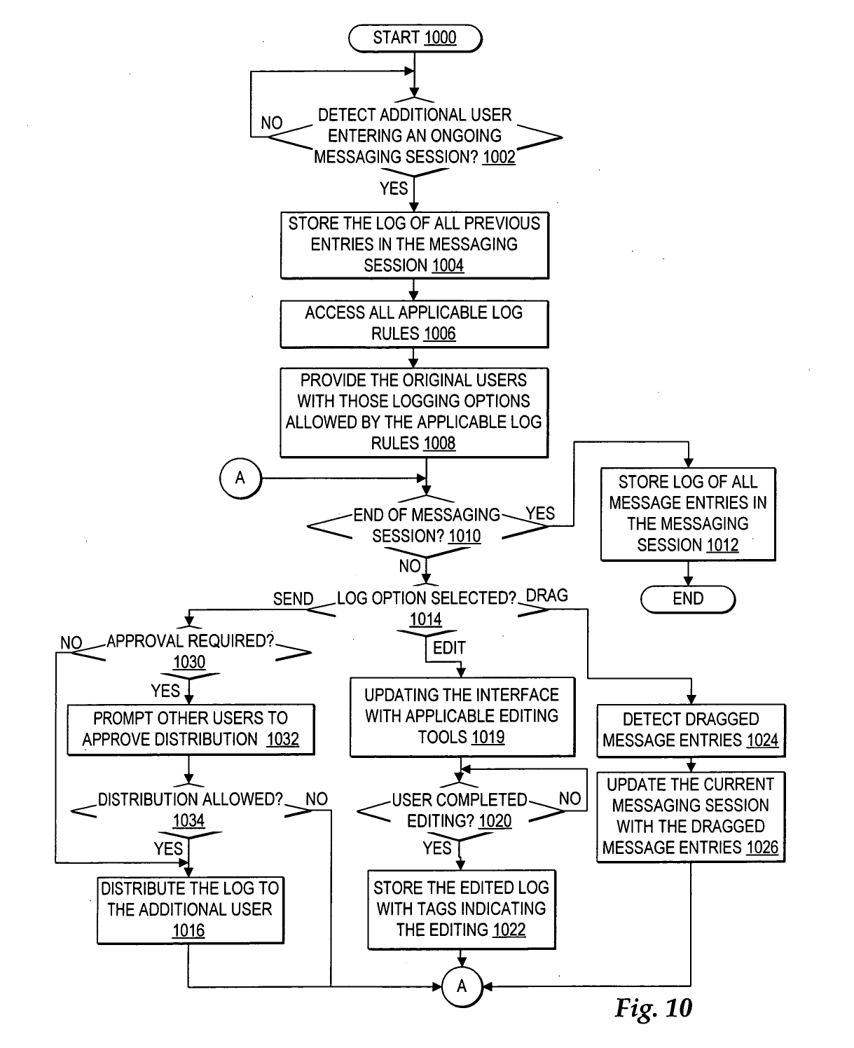

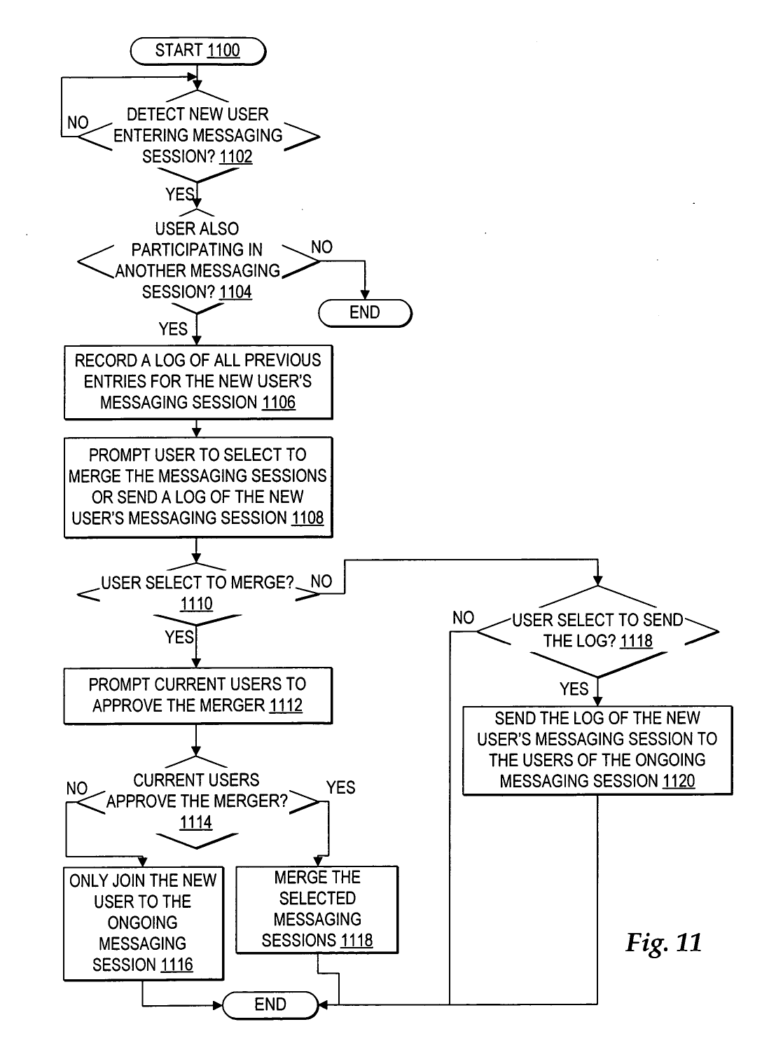

Processor 112 may include a general-purpose processor such as IBM's PowerPC™ processor that, during normal operation, processes data under the control of operating system and application software accessible from a dynamic storage device, such as random access memory (RAM) 114, and a static storage device, such as Read Only Memory (ROM) 116. The operating system may provide a graphical user interface (GUI) to the user. In a preferred embodiment, application software contains machine executable instructions that when executed on processor 112 carry out the operations depicted in the flowcharts of FIGS. 10-11, and other operations described herein. Alternatively, the steps of the present invention might be performed by specific hardware components that contain hardwired logic for performing the steps, or by any combination of programmed computer components and custom hardware components.

A computer program product may incorporate the present invention, where the computer program product is implemented through a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but may also be implemented as an external component. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, computer system 100 may download the present invention as a computer program product, receiving the program instructions from a remote computer such as a server 140 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or directly to an Internet Service Provider (ISP). In particular, network link 134 may provide wired and/or wireless network communications to one or more networks.

Network link 134 in turn provides data communication services through network 102. Network 102 may refer to the worldwide collection of networks and gateways that use a particular protocol, such as Transmission Control Protocol (TCP) and Internet Protocol (IP), to communicate with one another. Network link 134 and network 102 both use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces (not depicted) accessible via multiple peripheral component interconnect (PCI) bus bridges (not depicted) connected to an input/output controller (not depicted). In this manner, computer system 100 allows connections to multiple systems via network 102.

In addition, computer system 100 typically includes multiple peripheral components that facilitate communication. These peripheral components are connected to multiple controllers, adapters, and expansion slots coupled to one of the multiple levels of bus 122. For example, an audio output device 128 and audio input device 129 are connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

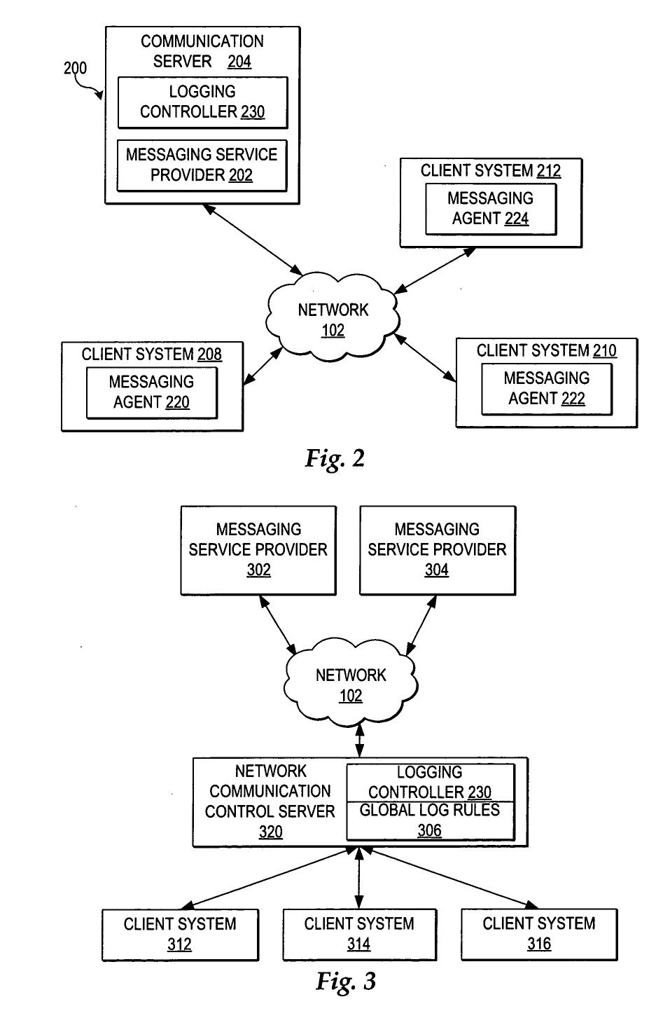

With reference now to FIG. 2, a block diagram depicts a distributed network system for facilitating messaging sessions and the distribution of logs of entries in messaging sessions in accordance with the present invention. Distributed network 200 is a network of computers in which one embodiment of the invention may be implemented. It will be understood that other embodiments of systems enabled to communicate via a connection may implement the present invention.

In the embodiment, distributed network 200 includes network 102, which is the medium used to provide communications links between various devices and computers connected together within distributed network 200. Network 102 may include permanent connections, such as wire or fiber optics cables, and temporary connections made through telephone connections and wireless transmission connections, for example.

In the depicted example, network 102 enables communicative connection between a communication server 204 and three client systems 208, 210, and 212. It will be understood that each of communication server 204 and client systems 208, 210, and 212 may be distributed in geographically disparate locations throughout heterogeneous types of computing systems operating within disparate local networks. In addition, it will be understood that distributed network 200 may include additional servers, clients, networks, and other devices that are not shown.

In one embodiment, distributed network 200 implements a client/server environment where communication server 204 performs as a server for responding to requests and client systems 208, 210, and 212 perform as clients requesting messaging services from collaboration communication server 204. Many different network architectures may implement the client/server environment of distributed network 200. In one example, distributed network 100 is the Internet with network 102 representing a worldwide collection of networks and gateways that use the TCP/IP suite of protocols to communicate with one another. Millions of high-speed data communication lines between major nodes or host computers enable the Internet. In another example, distributed network 200 includes an intranet, a local area network (LAN), or a wide area network (WAN). Moreover, distributed network 200 may include networks employing alternatives to a traditional client/server environment, such as a grid computing environment.

Within distributed network 200, each of client systems 208, 210, and 212 and communication server 204 may function as both a “client” and a “server” and may be implemented as a computer through a single or multiple computer systems, such as computer system 100 of FIG. 1. Further, while the present invention is described with emphasis upon communication server 204 facilitating the transfer of electronic messages, clients 208, 210, and 212 may also control communications by engaging in peer-to-peer network communications via network 102.

In particular, communication server 204 includes a messaging service provider 202 that facilitates one or more types of messaging communications. Messaging communications, performed in the form of messaging sessions, include, but are not limited to, instant messaging communications, chat room communications, text messaging, short message service (SMS) messaging, VoIP, and other forms of electronic communications that occur in “real-time” and are supported within distributed network 200. A “messaging session” describes a particular communication channel opened for real-time communication via network 102 between at least two users. Each user participating in a messaging session communicates through message entries which may include text, voice, video, graphics, robotic touch, motion entry, and tactile entry. An additional user may enter an already ongoing messaging session, but like a telephone conversation which occurs in real-time, the additional user initially only receives those message entries entered by users after the additional user joins.

It is important to note that for messaging communications, a single or multiple user identifiers (userIDs) may identify a single user, including, but not limited to, an e-mail address, an IM name, a chat name, a telephone number, and other electronic communication identifiers. In addition, a user may have a work user ID and a personal user ID. In addition, a user's ID may vary based on the device at which the user participates in a messaging session.

To facilitate messaging communications with messaging service provider 202, each of client systems 208, 210, and 212 include an agent, such as agents 220, 222, and 224, that enables a user at each of client systems 208, 210, and 212, through a supported user interface, to initiate a messaging session through messaging service provider 202 to another one of the client systems 208, 210, and 212 and enables a user at each of client systems 208, 210, and 212 to receive requests to participate in the messaging session and to participate in the messaging session. In one embodiment, messaging service provider 202 may also distribute collaborative agents 220, 222, and 224 as software that users install on client systems 208, 210, and 212. In another embodiment, users access collaborative agents 220, 222, and 224 at client systems 208, 210, and 212 as web pages that provide an interface for communication with messaging service provider 202.

Each of client systems 208, 210, and 212 and messaging service provider 202 detect a user's “presence” and may distribute the user's “presence” to the others of client systems 208, 210, and 212 and messaging service provider 202 in the form of a presence indicator, for example. A user's “presence” generally indicates a user's availability to participate in each type of collaborative communication available to the user. For example, a user's presence indicator may specify the user's availability to participate in a messaging session and to receive VoIP communications, thus indicating the user's availability to participate in two types of collaborative communications. In addition, a presence indicator may provide information in addition to “available” or “unavailable”, such as “on the phone”, “out to lunch”, “only business related communications”, and other specific indicators of presence selected by the user or determined by the system detecting a user's presence.

Communication server 204 also includes a logging controller 230. Logging controller 230 facilitates the recording, editing, sharing, and storing of message session entries facilitated by messaging service provider 202 into a log. In particular, a log includes both the content of the message session entries and tags added to give context to the message session entries. Tags may identify, for example, times and dates, the user associated with each message entry, when users enter and leave a messaging session, and any editing performed within the log of the message session entries.

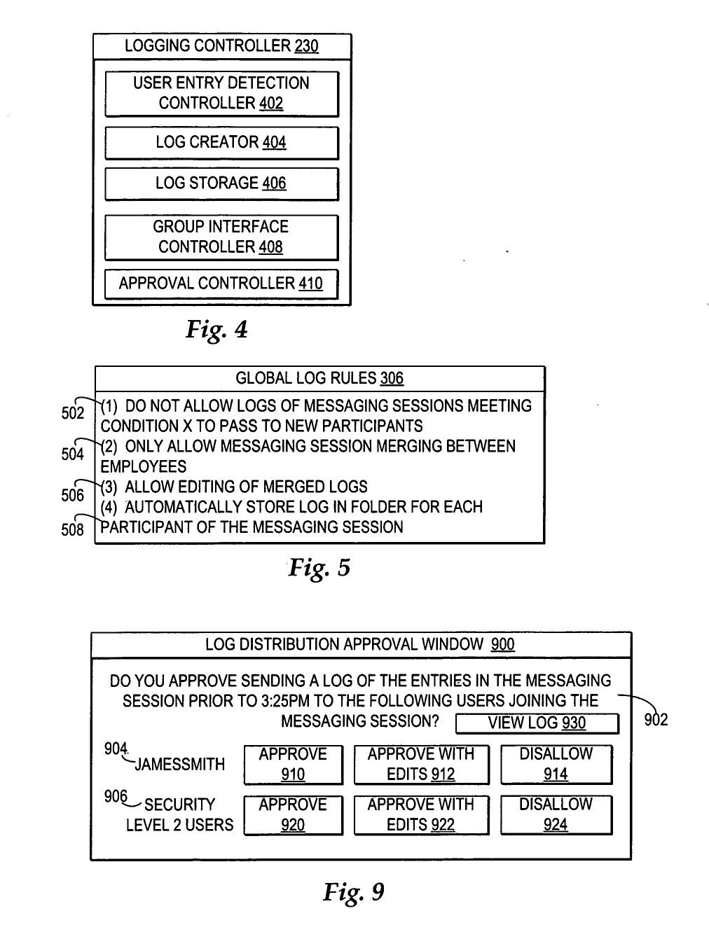

With reference now to FIG. 4, a block diagram depicts components of logging controller 230 in accordance with the method, system, and program of the present invention. It is important to note that the functions described with reference to the components of logging controller 230 may also be performed by agents 220, 222, and 224 and that logging controller 230 and agents 220, 222, and 224 may together perform the functions described with reference to logging controller 230.

According to an advantage, logging controller 230 detects when additional users enter an already ongoing messaging session and automatically records a log of all the message entries up to the point of a user entering the messaging session. Then, logging controller 230 enables the original users of the messaging session to select whether to distribute the log to the additional users. Further, logging controller 230 enables the original users to edit or select only portions of the log to distribute to the additional users. Moreover, logging controller 230 enables users to select portions of the log to add to the ongoing messaging session.

First, logging controller 230 includes a log creator 404 that monitors ongoing messaging sessions and records a log of those messaging sessions. In particular, log creator 404 adds tags to messaging session logs to provide context and stores messaging session logs in log storage 406 and other storage locations.

According to another advantage, logging controller 230 also includes a user entry detection controller 402. In one embodiment, log creator 404 alerts user entry detection controller 402 that a new user entering an ongoing messaging session is detected. In another embodiment, a messaging service provider may alert logging controller 230 when additional users enter an ongoing messaging session.

Responsive to an additional user entering an ongoing messaging session, user entry detection controller 402 pulls the message entries from the messaging session log that were entered prior to the entry of the additional user and enables the original users in the messaging session to select to distribute the log to the additional users. In one embodiment, the original users may select to distribute the log to additional users as a communication independent of the ongoing messaging session. In one example, the communication is an electronic mail. In another example, the communication is via a new pop-up messaging window. In another embodiment, the original users may select to drag and drop portions of the log into the ongoing messaging session, wherein logging controller 230 may intervene as a participant and add the selected message entries to the ongoing messaging session. In another embodiment, the original users may edit the log or select only portions of the log for logging controller 230 to distribute to the additional user.

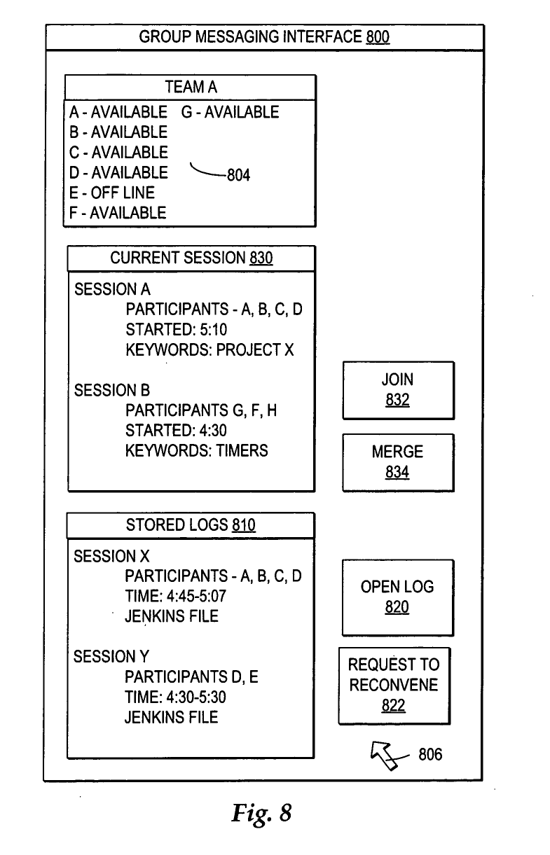

In addition, logging controller 230 includes a group interface controller 408 that facilitates an interface through which users may select logs to reopen the log or to select to reconvene the messaging session with the participants indicated in the log. As will be further described with reference to FIG. 8, group interface controller 408 enables users registered in a particular group to access stored messaging session logs and view current messaging sessions. In addition, users may select, via the group interface, to merge multiple current messaging sessions or join a current messaging session or to reconvene a messaging session with participants of a stored log. Responsive to user selections in the group interface, group interface controller 408 communicates with log creator 404 and messaging service provider 202 to perform the requested function. In particular, where a user requests to merge multiple messaging sessions or join an ongoing messaging session, either group interface controller 408 or messaging service provider 202 may first require that the participants agree to the merger or joinder.

Further, logging controller 230 includes an approval controller 410. As will be described with reference to FIG. 9, approval controller 410 determines which users must approve the distribution of a log and controls obtaining the approval of those users.

While the present invention is described with emphasis upon distributing a log to a user joining ongoing messaging session, user entry detection controller 402 may also detect a user leaving an ongoing messaging session and then, when the messaging session concludes, create a log of those entries made after the user left the messaging session and distribute the log to the departing user. Approval controller 410 may control the approval process of those users required to approve the distribution of the log to the departing user. In addition, those users remaining in the messaging session may select to edit the log before distribution to the departing user.

Referring now to FIG. 3, a block diagram depicts a network system with a logging controller for facilitating the distribution of messaging session logs according to logging rules in accordance with the method, system, and program of the present invention. As illustrated, multiple messaging service providers 302 and 304 provide messaging services to client systems 312, 314, and 316 via network 102. However, messaging sessions participated in through client systems 312, 314, and 316 are monitored and controlled by a network communication control server 320. In one example, client systems 312, 314, and 316 are systems within a business intranet with access to network 102 via network communication control server 320.

Network communication control server 320 includes logging controller 230 and global log rules 306. Logging controller 230 provides logging services to client systems 312, 314, and 316 independent of which of messaging service providers 302 and 304 facilitates the messaging session.

Global log rules 306 are rules for logging controller 230 to apply to control the distribution, editing, and storage of messaging session logs. In addition, global log rules may apply based on the messaging service provider used, the content of the messaging session, the participants of the messaging session, and other factors selected by the rulemaker. Rulermakers may include third parties, participants, messaging service providers, and other authorized to control messaging communications. It will be understood that network communication control server 320 may store global log rules 306 or may access global log rules 306 from multiple network locations.

With reference now to FIG. 5, a block diagram depicts examples of global log rules in accordance with the method, system, and program of the present invention. As illustrated, global log rules 306 includes a first rule indicated at reference numeral 502 that specifies “do not allow logs of sessions meeting condition X to pass to new participants.” When a logging controller applies the first rule, in one example, if a new participant enters an ongoing messaging session that meets condition X, then the new participant will not be allowed to receive a log of the entries in the messaging session prior to the time that the new participant entered the messaging session. It will be understood that “condition X” could be a single condition or a set of conditions and is depicted for illustrative purposes.

Global log rules 306 includes a second rule indicated at reference numeral 504 that specifies “only allow session merging between employees.” When a logging controller applies the second rule, in one example, if users attempt to merge ongoing messaging sessions into a single session, the communication server will only allow the merge if all the users participating in the merged session are employees.

In addition, global log rules 306 includes a third rule indicated at reference numeral 506 that specifies “allow editing of merged logs.” When a logging controller applies the third rule, in one example, users are allowed to edit logs resulting from merged messaging sessions.

Global log rules 306 also includes a fourth rule indicated at reference numeral 508 that specifies “automatically store log in folder for each participant”. When a logging controller applies the third rule, in one example, the log is stored in a network accessible storage location for each participant.

It will be understood that the first, second, third, and fourth rules are merely illustrative examples of the types of rules that a third party may set for controlling the recording, sharing, editing, and storing of messaging session logs and for controlling the merging of messaging sessions. In alternate embodiments, a third party may set other types of rules for controlling the recording, sharing, editing, and storing of messaging session logs and for controlling the merging of messaging sessions.

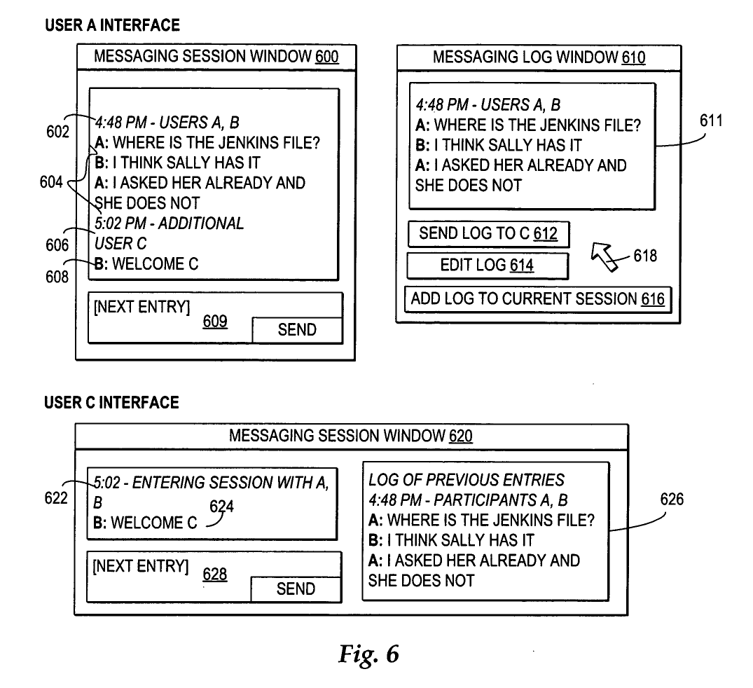

Referring now to FIG. 6, a block diagram illustrates the logging options provided to users participating in a messaging session when an additional user joins the ongoing messaging session. As illustrated, a messaging session window 600 includes the communications between participating users A and B, from the perspective of user A. The ongoing messaging session depicted in messaging session window 600 includes three entries indicated at reference numeral 604. In addition, the ongoing messaging session includes tagging, as illustrated at reference numeral 602, indicating the time the session started and the current participants.

When user C, the additional user, enters the ongoing messaging session between users A and B, the messaging session continues with users A, B, and C. In particular, from user A's interface, the messaging session dialog is updated with tagging 606 indicating the addition of user C and with a next message entry 608.

While users A and B can view all previous entries in the messaging session and all current and future messages, user C initially only views those entries indicated at reference numeral 608, which are entered after user C joins the messaging session. In particular, messaging session window 620 depicts the dialog 622 as only displaying the first message entry 624 made after user C enters the messaging session. As will be understood, user A may enter additional message entries via entry interface 609 and user C may enter additional message entries via entry interface 628.

According to an advantage, when additional user C enters the messaging session, the logging controller prompts user A with messaging log window 610. Messaging log window 610 includes a log 611 of the previous entries in the messaging session prior to the entry of user C. In addition, messaging log window 610 includes multiple selectable options that the user may select by placement of cursor 618.

A first option, depicted at reference numeral 612, prompts a user to select to “send the log to C”. If user A selects the first option, then the logging controller will pass log 611 to user C. In the present example, user A selects the first option, and responsive to the selection, messaging session window 620 is updated to display log 611 in display area 626 concurrently with the ongoing messaging session. In an alternate embodiment, the logging controller may open an independent window from messaging session window 620 to display log 611. Further, in an alternate embodiment, when user A selects to send log 611 to C, logging controller 230 may prompt user A to select whether to send the log as an e-mail or as an additional messaging session communication.

A second option, depicted at reference numeral 614, prompts a user to select to “edit the log”. If user A selects the second option, then the interface depicting log 611 becomes editable, such that a user may highlight those portions of log 611 to send to user C. In one example, the interface becomes editable by providing user A with selectable tools to delete, highlight, and add content and tags to log 611. After editing log 611, user A may then select the first option, to “send the log to C” and the logging controller will pass the edited log to user C. It is important to note that as user A edits messaging entries, the logging controller updates the tags for log 611. It will be understood logging controller may provide user A with multiple editing tools, as are understood in the art, for editing the text, images, audio, and video message entries included in the log depicted in log window 904. In one example, for editing text, the user may highlight text, delete text, add text, and spell check text. In another example, for editing sound, the user may cut out portions of a sound clip, add to the sound clip, or adjust the sound characteristics of the sound clip. Further, according to an advantage, editing message entries may include using editing tools to add emphasis to certain entries through adding coloring or bolding to text or volume increases to sound, for example. In another example, editing tools may include a time selection tool, such that the user may select to only include those message entries within a particular time period to the edited log.

A third option, depicted at reference numeral 616, prompts a user to select to “add entries from the log to the current messaging session”. If user A selects the third option, then each entry log 611 becomes a “drag and drop” entry. In particular, a user may select an entry within log 611 and drag the entry to messaging session window 600, to add the entry to the entries included in the messaging session between users A, B and C, thus enabling user C to view selected entries. In particular, when the logging controller detects a user drag and drop entries into an ongoing messaging session window, the logging controller may add the dropped entries to the messaging session dialog with tagging to indicate that the messaging session entries are from the log of previous entries.

In one embodiment, user C may select preferences for viewing the logs, such as the log in display area 626. In one example, a user may select to receive a static view of the log, such that user C then decides whether to scroll through the log and decides which audio or video clips in the log to play. In another example, a user may select to receive an automatically scrolling view of the log, where the user selects a rate that the log should begin to scroll the log. Further, where the log includes audio and video clips, an auto scrolling view would automatically play each clip as the log scrolls up. In yet another example, a user may select to view only those entries in the log entered by a particular user or entered within a particular time period.

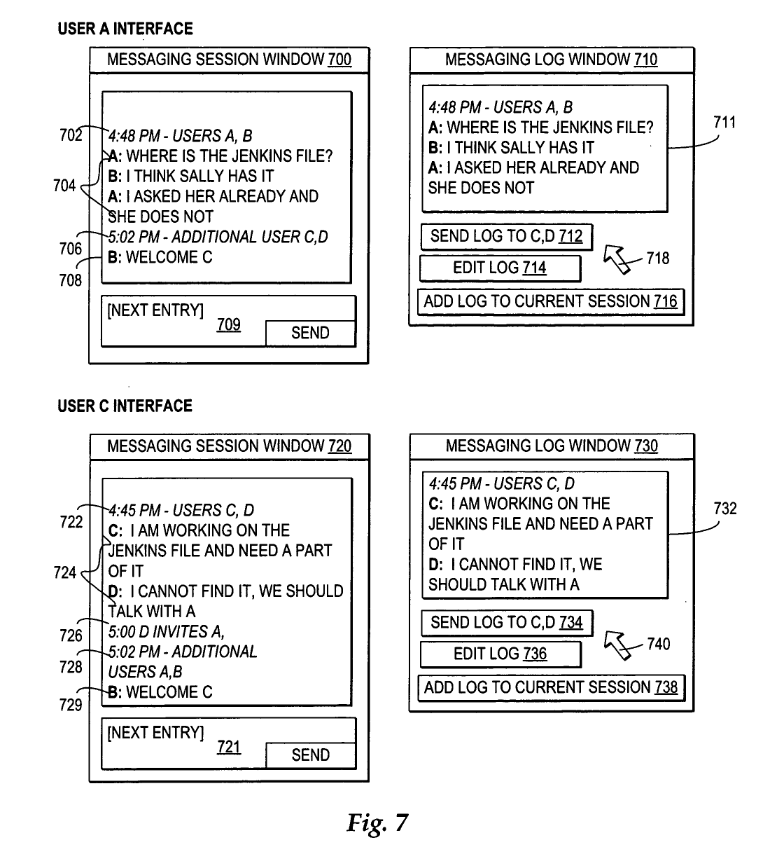

With reference now to FIG. 7, a block diagram illustrates the logging options provided to users merging messaging sessions. As illustrated, a messaging session window 700 includes the message entries in the ongoing communication between participating users A and B, from the perspective of user A. In addition, a messaging session window 720 includes the message entries in the ongoing communication between participating users C and D, from the perspective of user D.

In the example, users C and D begin communicating, as illustrated at tag 722, and decide to talk with user A, as indicated in message entries 724. As indicated by tag 726, user D requests that the messaging service provider invite user A to join the ongoing messaging session between users C and D. Although not depicted, the logging controller detects that user A is already participating in a messaging session and offers user A the opportunity to join the messaging session with users C and D alone or with user B. In the example, user A selects to merge the messaging sessions. In merging the messaging sessions, the messaging service provider adds all the users to a single messaging session that continues in the same messaging windows displayed to each user before the merger. As a result of the merger of the messaging sessions, tag 706 in messaging session window 700 indicates the addition of users C and D and tag 728 in messaging session window 720 indicates the addition of users A and B. Entries made by user A in entry interface 709 and by user C in entry interface 721 are updated in the messaging session windows for users A, B, C, and D. For example, after the merger, user B enters a message entry which is updated as entry 708 in messaging session window 700 and entry 729 in messaging session window 720.

Upon merging the two messaging sessions, the logging controller detects that users A and B have entered an ongoing messaging session and that users C and D have entered an ongoing messaging session. The logging controller then prompts user A with messaging log window 710 depicting log 711 of message entries 704 and tag 702, entered prior to the merging of the messaging sessions. User A may select, through the placement of cursor 718, the first option 712 to send the log to C and D, a second option 714 to edit the log, and a third option 716 to add the log to the current session, where the first, second and third options are more fully described with reference to FIG. 6. In addition, the logging controller prompts user C with messaging log window 730 depicting log 732 of message entries 724 and tag 722, entered prior to the merging of the messaging sessions. User C may select, through the placement of cursor 740, the first option 734 of to send the log to A and B, a second option 736 to edit the log, and a third option 738 to add the log to the current session, where the first, second and third options are more fully described with reference to FIG. 6.

In an alternate embodiment, prior to the occurrence of a merger of messaging sessions, each merging user may be required to approve the merger. In addition, the global log rules may effect what type of mergers and distribution of logs that the logging controller may perform.

With reference now to FIG. 8, a block diagram illustrates an example of a group messaging interface in accordance with the method, system, and program of the present invention. Users may join a group, team or project with a common interface for messaging communications related to the group, team or project. In one embodiment, the logging controller facilitates users in selecting the preferences for establishing the common interface, such as a group messaging interface 800.

In one example, group messaging interface 800 provides a common interface for instant messaging communications related to a “team A”. “Team A” includes multiple users, as illustrated at reference numeral 804, where the presence is displayed. The user's presence indicates the actual availability of the user to participate in instant messaging sessions or other forms of communication. In addition, other messaging session characteristics may be depicted at reference numeral 804. For example each user's current participation may be displayed where the user's current participation indicates the current instant messaging session in which the user is participating, whether the other participants are team members, and the duration of the session.

In addition, group interface 800 depicts the current messaging sessions 830 ongoing between members of “team A” and non-members. A user accessing group interface 800 may select to join an ongoing messaging session by selecting from among current instant messaging sessions 830 and selecting the join option depicted at reference numeral 832 by the positioning of cursor 806 or other selection input. Responsive to a selection of the join option, the logging controller may prompt current participants of the target messaging session to approve the joining user. In addition, a user may select from among current instant messaging session 830 and select from among members 804 and select the join option. Responsive to the selection of the join option, the logging controller would prompt the selected member to join the selected instant messaging session.

In addition, a user accessing group interface 800 may select to merge ongoing messaging sessions by selecting multiple sessions from among current instant messaging sessions 830 and selecting the merge option depicted at reference numeral 834. Responsive to a selection of the merge option, the logging controller may prompt current participants of the target messaging sessions to approve the merger. The user requesting the merging may or may not be a participant in one of the merging messaging sessions.

Further, group interface 800 illustrates stored logs 810 of logs of messaging sessions participated in by members of “team A” and non-members. In particular, characteristics such as the participants, time, date, and keywords of each messaging session may be depicted with each log file. In one example, a user may select a log from stored logs 810 and select the open file option, as depicted at reference numeral 820, to trigger the logging controller to open the selected log file. In another example, a user may select a log from stored logs 810 and select the reconvene option, as depicted at reference numeral 822, to trigger the logging controller to initiate a messaging session with all the previous participants with the stored log displayed in the messaging session. In one embodiment, the logging controller detects those previous participants whose presence indicates availability to participate in the messaging session and requests that the messaging service provider prompt those previous participants to participate in the new messaging session. Also, the logging controller prompts the messaging service provider to monitor those previous participants whose presence indicates lack of availability to participate in the messaging session and prompt those participants to participate if their presence later indicates availability and the new messaging session is still ongoing.

Referring now to FIG. 9, there is depicted an illustrative example of an interface for prompting users to approve a distribution of a log to an additional user. In particular, prior the distribution a log file to a user entering an ongoing messaging session, there may be requirements for approval of the distribution by other users participating in the messaging session or by users not participating in the messaging session.

Approval controller 410, of FIG. 4, detects those users whose approval is required for the distribution of a log file and prompts those users to approve the distribution. Approval controller 410 may detect approval requirements because of security levels assigned to each user, for example. In addition, approval controller 410 may detect approval requirements from other hierarchical assignments of users. Further, a particular user may select to allows be prompted to approve distributions of logs of messaging sessions in which that user. is a participant.

In one example, approval controller 410 triggers the display of log distribution approval window 900 as the prompting of a user to approve a distribution. In the example, a message 902 indicates the approval requested. In particular, message 902 indicates that the user's approval of a distribution of a log of the entries in the messaging session entered prior to the arrival of a user or group of users is requested. It will be understood that message 902 may include additional information identifying the messaging session.

In addition, in the example, the user may select to view the current log by selecting the view log button 930. The current log may include edits by another user or users.

In the example, the user may select, by user identifier or other identifier, whether to approve, approve with edits, or disallow a log distribution. In particular, as illustrated at reference numeral 904, an individual user ID of “JAMESSMITH” indicates a single user to whom approval is requested. The user may select approve button 910 to approve the distribution, approve with edits button 912 to trigger an editing interface, and disallow button 914 to disallow the distribution. In one example, where one user selects approve with edits button 912 and edits the current log, then approval controller 410 will then prompt all the users to approve the distribution of the updated current log.

In addition, in the example, the user may select, but security level, whether to approve, approve with edits, or disallow a log distribution. In the example, as depicted at reference numeral 906, approval of distribution to “security level 2 users” is requested. The user may select approve button 920 to approve the distribution, approve with edits button 922 to trigger an editing interface, and disallow button 924 to disallow the distribution. In one embodiment, the individual “JAMESSMITH” is a security level 2 user, however, in an alternate embodiment, “JAMESSMITH” and “security level 2 users” are independent of one another. In addition, in one embodiment, the same log file is sent to both “JAMESSMITH” and the “security level 2 users”, however, in an alternate embodiment, different log files are sent.

With reference now to FIG. 10, there is depicted a high level logic flowchart of a process and program for controlling distribution of an instant messaging session log to a user joining an ongoing instant messaging session. As illustrated, the process starts at block 1000 and thereafter proceeds to block 1002. Block 1002 depicts a determination whether the logging controller detects a new user entering an ongoing instant messaging session. In particular, when instant messaging sessions are merged, the logging controller detects new users entering each of the merged ongoing instant messaging sessions. When the logging controller detects a new user entering an ongoing instant messaging session, then the process passes to block 1004. Block 1004 illustrates storing a log of all previous entries in the messaging session prior to the entry of the new user. Thereafter, block 1006 depicts accessing the applicable logging rules for the current users in the messaging session. Next, block 1008 illustrates providing the original participants in the messaging session with those options for distributing the log of previous entries permitted by the applicable logging rules, and the process passes to block 1010.

Block 1010 depicts a determination whether the logging controller detects that the ongoing instant messaging session has ended. If the ongoing instant messaging session has ended, then the process passes to block 1012. Block 1012 illustrates storing a log of all the message entries for the duration of the messaging session, and the process ends. It is important to note that in storing the log of all the message entries, the logging controller may add additional tags provide context for the messaging session log.

Returning to block 1010, if the ongoing instant messaging session has not ended, then the process passes to block 1014. Block 1014 depicts a determination by the logging controller that a logging option is selected. In one example, if a user selects a logging option to send the log, then the process passes to block 1030. Block 1030 depicts a determination by the logging controller whether approval of the distribution is required. If approval is not required, then the process passes to block 1016. Block 1016 illustrates sending the log to the joining user for display to the joining user, and the process returns to block 1010. Otherwise, at block 1030, if approval is required, then the process passes to block 1032. Block 1032 depicts prompting the other users required to approve the distribution to select whether to approve the distribution. In particular, as described with reference to FIG. 9, users may select whether to approve the distribution on a user by user basis and users may select to approve the distribution with editing, which would trigger another round of approvals for distribution of an edited version of the log. Next, block 1034 depicts a determination by the logging controller of whether the distribution is allowed. If the distribution is not allowed, then the process passes to block 1010. If the distribution is allowed, then the process passes to block 1016.

Alternatively, at block 1014, if a user selects a logging option to edit the log, then the process passes to block 1019. Block 1019 depicts updating the user interface with applicable editing tools. In particular, if the message entries in the log are audio entries, then audio editing tools are applicable. Next, block 1020 depicts a determination by the logging controller whether the user has completed editing the log. If the editing is complete, then the process passes to block 1022. Block 1022 depicts storing the edited log, and the process returns to block 1010.

Further, alternatively, at block 1014, if a user selects a logging option to drag and drop from the log, then the process passes to block 1024. Block 1024 depicts detecting dragged message entries from the log to the current messaging window. Next, block 1026 depicts updating the current messaging session with the dragged and dropped message entry, and the process returns to block 1010.

Referring now to FIG. 11, there is depicted a high level logic flowchart of a process and program for controlling distribution of an instant messaging log of a first instant messaging session when a user participating in the first ongoing messaging session joins a second instant messaging session. As illustrated, the process starts at block 1100 and thereafter proceeds to block 1102. Block 1102 depicts a determination whether the logging controller detects a user entering a messaging session. In particular, the logging controller may detect the user entering an ongoing messaging session or a new messaging session. If the logging controller detects the user entering a messaging session, then the process passes to block 1104. Block 1104 depicts a determination whether the logging controller detects that the user is also already participating in second ongoing messaging session. If the user is also already participating in a second ongoing messaging session, then the process passes to block 1106; otherwise, the process ends.

Block 1106 depicts recording a log of all the previous entries for the second ongoing messaging session prior to the point that the user joined entered the other messaging session. Next, block 1108 illustrates prompting the user to select to merge the messaging sessions or send a log of the second messaging session to the participants of the messaging session being joined. Thereafter, block 1110 depicts a determination whether the user selects to merge the messaging sessions.

At block 1110, if the user selects to merge the messaging sessions, then the process passes to block 1112. Block 1112 depicts the logging controller prompting the current users in the messaging sessions to be merged to approve the merger. Next, block 1114 illustrates a determination whether the merger is approved. If the merger is not approved, then the process ends. If the merger is approved, then the process passes to block 1116. Block 1116 depicts the logging controller joining the instant messaging sessions, and the process ends. In particular, when the logging controller joins messaging sessions, the flowchart of FIG. 10 is triggered to prompt users of the joined session with regard to the messaging logs of previous entries in each of the joined messaging sessions.

Otherwise, at block 1111 if the user does not select to merge the messaging sessions, then the process passes to block 1118. Block 1118 depicts a determination whether the user selects to send the log of the second messaging session entries to the users participating in the messaging session being joined. If the user does not select to send a log, then the process ends. If the user selects to send a log, then the process passes to block 1120. Block 1120 depicts distributing the log of the second messaging session entries to the users participating in the messaging session being joined, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for enabling distribution of a log of an ongoing messaging session, comprising:
responsive to detecting by at least one computer monitoring an ongoing messaging session at least one additional user joining said ongoing messaging session between a plurality of users, designating at said computer a log of at least one previous entry in said ongoing messaging session entered prior to said additional user entering said ongoing messaging session; and
responsive to a selection by at least one of said plurality of users to distribute said log, distributing by said computer said log to said additional user, such that said additional user is updated with said at least one previous entry in said ongoing messaging session upon joining said ongoing messaging session.

2. The method according to claim 1, further comprising:
detecting by said computer said additional user joining said ongoing messaging session when said ongoing messaging session merges with a second ongoing messaging session, wherein said additional user was a participant in said second ongoing messaging session.

3. The method according to claim 1, wherein said distributing step further comprises:
detecting by said computer at least one logging rule for controlling distributions of messaging session logs from said computer for at least one of said plurality of users and said additional user; and
blocking by said computer distribution of said log to said additional user if said logging rule prohibits said distribution.

4. The method according to claim 1, wherein said distributing step further comprises:
distributing by said computer said log to said additional user in a second communication channel independent of a first communication channel for said ongoing messaging session.

5. The method according to claim 1, wherein said distributing step further comprises:
detecting by said computer a selection by one user of said plurality of users to drag a particular entry from said log into a current entry display for said ongoing messaging session; and
responsive to detecting said selection to drag said particular entry, distributing by said computer said particular entry to said additional user via said ongoing messaging session.

6. The method according to claim 1, wherein said distributing step further comprises:
detecting by said computer a selection by one of said plurality of users from among said at least one previous entry; and
distributing by said computer said log with only said selection from among said at least one previous entry.

7. The method according to claim 1, wherein said distributing step further comprises:
detecting by said computer an adjustment to at least one previous entry in said log by one of said plurality of users; and
distributing by said computer said log with said adjustment to said at least one previous entry.

8. The method according to claim 1, wherein said distributing step further comprises:
controlling by said computer output of said log in a display interface accessible to said additional user; and
directing said log to scroll within said display interface at a particular rate.

9. The method according to claim 1, further comprising:
responsive to detecting a conclusion to said ongoing messaging session, enabling by said computer at least one of said plurality of users and said additional user to select with a single input to reconvene said ongoing messaging session between said plurality of users and said additional user.

10. A system for enabling distribution of a log of an ongoing messaging session, comprising:
at least one computer for monitoring an ongoing messaging session between a plurality of users;
said computer further comprising:
means, responsive to detecting at least one additional user joining said ongoing messaging session between a plurality of users, for designating a log of at least one previous entry in said ongoing messaging session entered prior to said additional user entering said ongoing messaging session; and
means, responsive to a selection by at least one of said plurality of users to distribute said log, for distributing by said computer said log to said additional user.

11. The system according to claim 10, said computer further comprising:
means for detecting said additional user joining said ongoing messaging session when said ongoing messaging session merges with a second ongoing messaging session, wherein said additional user was a participant in said second ongoing messaging session.

12. The system according to claim 10, wherein said means for distributing further comprises:
means for detecting at least one logging rule for controlling distributions of messaging session logs from said computer for at least one of said plurality of users and said additional user; and
means for blocking distribution of said log to said additional user if said logging rule prohibits said distribution.

13. The system according to claim 10, wherein said means for distributing further comprises:
means for distributing said log to said additional user in a second communication channel independent of a first communication channel for said ongoing messaging session.

14. The system according to claim 10, wherein said means for distributing further comprises:
means for detecting a selection by one user of said plurality of users to drag a particular entry from said log into a current entry display for said ongoing messaging session; and
means, responsive to detecting said selection to drag said particular entry, for distributing said particular entry to said additional user via said ongoing messaging session.

15. The system according to claim 10, wherein said means for distributing further comprises:
means for detecting a selection by one of said plurality of users from among said at least one previous entry; and
means for distributing said log with only said selection from among said at least one previous entry.

16. The system according to claim 10, wherein said means for distributing further comprises:
means for detecting an adjustment to at least one previous entry in said log by one of said plurality of users; and
means for distributing said log with said adjustment to said at least one previous entry.

17. The system according to claim 10, wherein said means for distributing further comprises:
means for controlling output of said log in a display interface accessible to said additional user; and
means for directing said log to scroll within said display interface at a particular rate.

18. The system according to claim 10, said computer further comprising:
means, responsive to detecting a conclusion to said ongoing messaging session, for enabling at least one of said plurality of users and said additional user to select with a single input to reconvene said ongoing messaging session between said plurality of users and said additional user.

19. A program for enabling distribution of a log of an ongoing messaging session, said program embodied in a computer-readable medium, said program comprising computer-executable instructions which cause a computer to perform the steps of:
responsive to detecting at least one additional user joining an ongoing messaging session between a plurality of users, designating a log of at least one previous entry in said ongoing messaging session entered prior to said additional user entering said ongoing messaging session; and
responsive to a selection by at least one of said plurality of users to distribute said log, distributing said log to said additional user.

20. The program according to claim 19 for enabling distribution of a log of an ongoing messaging session, further comprising the step of:
detecting said additional user joining said ongoing messaging session when said ongoing messaging session merges with a second ongoing messaging session, wherein said additional user was a participant in said second ongoing messaging session.
